(19) United States
(12) Patent Application Publication
(10) Pub. No.: US 2015/0281824 A1
(43) Pub. Date: Oct. 1, 2015

(54) METHODS TO CONSERVE REMOTE BATTERIES

(71) Applicant: EchoStar Technologies L.L.C., Englewood, CO (US)

(72) Inventors: Phuc H. Nguyen, Parker, CO (US); Christopher William Bruhn, Aurora, CO (US)

(73) Assignee: EchoStar Technologies L.L.C., Englewood, CO (US)

(21) Appl. No.: 14/229,684

(22) Filed: Mar. 28, 2014

(51) Int. Cl. H04R 1/10

(52) U.S. Cl. CPC H04R 1/1041; H04R 2420/07

(57) ABSTRACT

A wireless headset receives audio data wirelessly from a television receiver and outputs audio to the user through earphones. The wireless headset includes an inertial sensor that detects an orientation of the user's head. If the orientation of the user's head indicates that the user is sleeping, then wireless headset turns off the wireless receiver, thereby saving battery life.

### BACKGROUND

1. Technical Field

The present disclosure relates to the use of streaming audio data to a wireless headset. The present disclosure relates, more particularly, to conserving the battery life of a wireless headset streaming audio data.

2. Description of the Related Art

Media programs such as television programming, movies, video games, etc. typically include a video portion and an audio portion. The video portion of the media programs is commonly displayed on a television or computer monitor. The audio portion of the media programs is commonly output from speakers connected to the television or monitor, or from a home entertainment sound system including a large arrangement of speakers. However, it has become increasingly common for users to receive the audio portion of a media program through the headphones of a wireless headset. The wireless headset receives the audio portion of the media program wirelessly from a television receiver, a game console, a DVD player, stereo system, etc. The wireless headset reproduces the audio portion for the user via the earphones of the wireless headset.

Wireless headsets are typically powered by a battery or batteries. A comparatively large amount of power is consumed by the wireless headset when the wireless transceiver, which receives the audio portion of the media program, is active. There are many instances in which the wireless transceiver of the wireless headset continues to function when the user is no longer listening. This consumes battery power and causes the user to need to replace or recharge batteries more frequently than desired.

### BRIEF SUMMARY

One embodiment is a television receiver that transmits the audio portion of a media program to a wireless headset worn by a user. The television receiver is configured to receive user input indicating that after a particular media program or at a particular time, the television receiver should transmit a command to the wireless headset that causes the wireless headset to turn off. Thus, when a particular media program has ended, or when a particular time has arrived, the television receiver transmits a command to the wireless headset causing the wireless headset to turn off. In this way, if a user intends to watch a media program and plans to fall asleep during the program or plans to go to bed after the program, the wireless headset will not needlessly consume batteries long after the user has stopped using the wireless headset.

One embodiment is a wireless headset that is configured to receive the audio portion of the media program from a television receiver or another media device. The wireless headset includes a sensor that monitors a physical trait of the user. If the physical trait of the user indicates that the user has fallen asleep, then the wireless headset turns off. In one embodiment the sensor includes an inertial sensor that detects the movements of the user's head. If the movements of the user's head indicates that the user is asleep, then the wireless headset turns off. Alternatively, the inertial sensor can detect the orientation of the user's head, for example whether the user's head is upright or tilted to one side. If the orientation of the user's head indicates that the user is asleep, then the wireless headset turns off.

In one embodiment the monitoring and sending of commands is done by the television receiver or other media device that is configured to transmit an audio portion of the media program to the wireless headset.

In one embodiment, the sensor includes a camera that monitors the user's eyes to see if they are closed for a prolonged period of time. In one embodiment the camera monitors the orientation of the user's head to detect if the orientation of the user's head indicates that the user has fallen asleep.

### BRIEF DESCRIPTION OF THE SEVERAL VIEWS OF THE DRAWINGS

FIG. 1 is a block diagram of a system including a television receiver and a wireless headset according to one embodiment.

FIG. 2 is an illustration of a residential setting including a user wearing a wireless headset and operating a television receiver according to one embodiment.

FIG. 3 is a block diagram of a wireless headset according to one embodiment.

FIG. 4 is a block diagram of a television receiver according to one embodiment.

FIG. 5A is an illustration of user wearing a wireless headset while awake according to one embodiment.

FIG. 5B is an illustration of a user wearing a wireless headset while asleep according to one embodiment.

FIG. 6 is an illustration of a television receiver monitoring a user wearing a wireless headset according to one embodiment.

FIG. 7 is a flowchart illustrating a method for preserving batteries in a wireless headset according to one embodiment.

FIG. 8 is a flowchart illustrating a method for preserving batteries in a wireless headset according to one embodiment.

### DETAILED DESCRIPTION

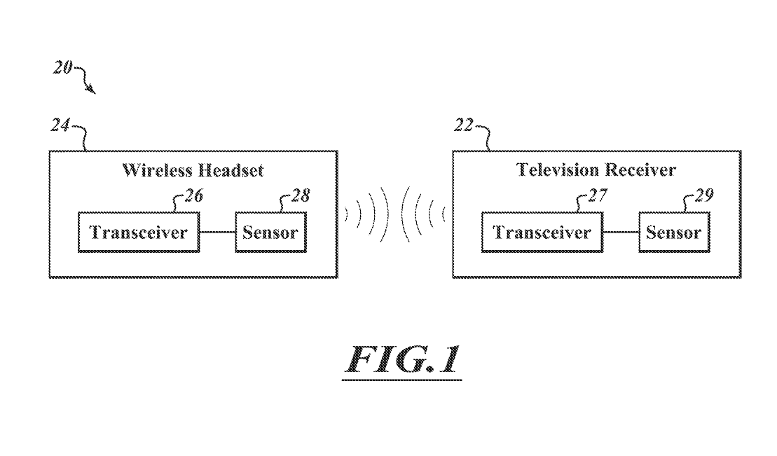

FIG. 1 is a block diagram of a system 20 including a television receiver 22 and a wireless headset 24. The wireless headset 24 includes a transceiver 26 and a sensor 28.

The television receiver 22 receives media content from a television programming distributor such as a cable television distributor, satellite television distributor, an Internet television distributor, or a terrestrial broadcast television distributor. The media content includes media programs such as television programs, movies, pay-per-view movies, radio programs, or other types of media content.

The television receiver 22 typically displays the video portion of a media program on a display coupled to the television receiver 22. The television receiver 22 outputs an audio portion of the media program to the wireless headset 24 worn by a user. In particular, the television receiver 22 wirelessly transmits a signal including the audio portion of the media program to the wireless headset 24. The transceiver 26 of a wireless headset 24 receives the signal from the television receiver 22 and outputs the audio portion of the media program to headphones of the wireless headset 24.

The wireless headset 24 will typically be powered by batteries. If the batteries become depleted, the wireless headset 24 will become inoperable until the batteries are replaced or recharged. The transceiver 26 of the wireless headset 24 consumes a relatively large amount of energy when it is receiving the audio portion of a media program. To avoid the inconvenience of having to frequently replace rechargeable batteries of the wireless headset 24, the system 20 of FIG. 1 includes functionality designed to reduce the amount of power consumed by the wireless headset, particularly when the user is no longer using the wireless headset or has fallen asleep.

In one embodiment, the television receiver 22 includes an electronic programming guide which can be accessed by the user to view which media programs are available on particular channels at particular times. By operating a remote control, or by utilizing inputs coupled directly to the television receiver 22, the user can access the electronic programming guide and can select a media program to view. When the user selects a media program to view, the user can also enter input directing the television receiver to send a command to the wireless headset 24 to turn off at the end of the selected media program. At the end of the media program, the television receiver 22 will transmit a wireless command signal to the wireless headset 24 directing the wireless headset 24 to enter a reduced power state or to turn off entirely.

This can be of particular use when the user anticipates that he will stop using the wireless headset 24 at the end of the selected media program, or if the user anticipates that he may fall asleep during the media program. In many cases a user plans to stop using the wireless headset at the end of the selected media program, but forgets to turn off the wireless headset 24 or the television receiver 22. This is particularly common in an instance in which the user turns off a television coupled to the television receiver 22, but fails to turn off the television receiver 22. The television receiver 22 may continue to broadcast the audio portion of a subsequent media program to the wireless headset 24. If the user has also forgotten to turn off the wireless headset 24, the transceiver 26 of the wireless headset 24 will continue to operate and receive the audio portion of the subsequent media program. The continued operation of the transceiver 26 will deplete the batteries of the wireless headset 24 even though the user is no longer using the wireless headset 24. When the user returns at a future time to use the wireless headset 24, he may find that the batteries are entirely depleted. It is both inconvenient and expensive to repeatedly recharge the batteries or purchase new batteries.

However, the functionality of the system 20 allows the user to avoid this situation by enabling the user to choose to turn off the wireless headset 24 at the end of a selected media program. Thus, if the user has scheduled the television receiver 22 to turn off the wireless headset 24 at the end of a selected media program, the television receiver 22 will transmit a command to the wireless headset 24 instructing wireless headset 24 to turn off the transceiver 26 or to shut down altogether. If the user then forgets to turn off the wireless headset 24 or the television receiver 22, the wireless headset 24 will nevertheless stop the function of the transceiver 26. In this way the battery life of the wireless headset 24 is not needlessly wasted.

Alternatively, the user of the wireless headset 24 can instruct the television receiver 22 to turn off the wireless headset 24 at a particular time of day. For instance, the user may plan to relax and channel surf at a later time in the evening, without a plan to view any particular media program. Nevertheless the user believes that he will most likely go to bed by midnight. Or, the user can set his planned schedule to be in bed by midnight. The user can thus instruct the television receiver 22 to turn off the wireless headset 24 at midnight. Thus, if the user has gone to bed or if the user has fallen asleep while watching a media program, at midnight the television receiver 22 will transmit a command to the wireless headset 24 causing the wireless headset 24 to turn off the transceiver 26 or to shut down entirely. The user can store a long term, scheduled program to turn off at selected times each day. In this way, the batteries of the wireless headset 24 can be preserved when the user is no longer viewing the media program.

This functionality can also be used by media devices other than a television receiver 22. For example, the wireless headset may receive the audio portion of a media program from a game console, a computer, a tablet, a stereo system, or other kinds of media devices. The functionality described above with respect to the television receiver 22 can also be implemented in these other media devices.

In one example, a user of the wireless headset may be playing a video game and receiving an audio portion of the videogame, as well as audio communication from other players, through the wireless headset 24. The user can schedule the game console or other device to turn off the wireless headset 24 at a particular time or after the user is no longer playing in a particular game. In this way, the wireless headset 24 does not needlessly deplete the batteries after the user is no longer using the wireless headset 24. Those of skill in the art will recognize, in light of the present disclosure, that the energy-saving functionality can be implemented in many other kinds of devices that communicate with a wireless headset 24. All such other devices fall within the scope of the present disclosure.

In one embodiment, the sensor 28 of the wireless headset 24 detects when the user of the wireless headset 24 has fallen asleep. The sensor 28 monitors a physical state of the user and detects whether the user is awake or asleep based on the monitored physical state of the user. When the sensor 28 detects that the user has fallen asleep, the sensor 28 outputs a signal to control circuitry of the wireless headset 24 causing the wireless headset 24 to turn off the transceiver 26 or to shut down altogether.

In one example, the sensor 28 is an inertial sensor that detects the motion of the user's head. Commonly, when a user is awake, the user's head will make particular shifting movements such as nodding, quickly moving to look another direction then moving back, and many other kinds of movements. In contrast, when the user is asleep, the head moves very little or only makes certain kinds of movements particular to a state of sleep. Based on these movements, the sensor 28 can detect whether the user is awake or asleep. If the motion of the user's head, as detected by the sensor 28, indicates that the user is asleep, the sensor 28 can output a signal causing the wireless headset 24 to turn off the transceiver 26 or to shut down altogether.

Alternatively, the sensor 28 can include a microphone that senses the breathing of the user. The breathing pattern of the user can provide an indication of whether the user is asleep or not. When a user falls asleep, the user's breathing pattern changes in a known manner. In particular, the frequency of breathing decreases when a user is asleep. The microphone can detect the users breathing pattern and can determine if the user has fallen asleep based on the breathing pattern. If the microphone determines that the user has fallen asleep, based on the users breathing pattern, the microphone can cause the wireless headset 24 to turn off the transceiver 26 or to shut down altogether.

Sensor 28 can also include a pulse rate monitor that is capable of measuring the heart rate of the user. The heart rate of the user can provide an indication of whether the user has fallen asleep. In particular, when the user falls asleep, the heart rate of the user typically decreases to a level that is significantly lower than the heart rate of the user when the user is awake. If the pulse rate monitor detects that the pulse rate has decreased to a level indicative of the user being asleep, the pulse rate monitor can cause the wireless headset 24 to turn off the transceiver 26 or to shut down altogether.

In one embodiment, when the sensor 28 causes the wireless headset 24 to turn off the radio or to shut down altogether, the wireless headset 24 first transmits a signal to the television receiver 22 indicating that the user is asleep. The television receiver 22 can then enter a low power state while the user is asleep. The low power state can include ceasing transmission of the audio portion to the wireless headset 24 and ceasing transmission of the video portion to the display. The low power state can further include turning off the television receiver 22 altogether. The television receiver 22 can also transfer the shutdown command to the display or to other media devices coupled to the television receiver 22. In this way, when the wireless headset 24 detects that the user has fallen asleep, the wireless headset 24 can also cause other media devices to enter a reduced power state or to shut down altogether, thereby reducing the power consumed by the media devices while the user is asleep.

When the television receiver 22 or other media device receives a signal from the wireless headset 24 indicating that a user is asleep, the television receiver 22 or the media device can take steps to ensure that the user does not miss any portion of the media program that the user is watching. For example, if the user is watching a television program broadcast at a particular time, upon being notified that the user has fallen asleep the television receiver 22 can either pause or automatically record the program to a DVR. The recording can be the remaining portion of the program or going back to record the entire program, which can be done easily since the last few hours of viewed program content are stored in a buffer. In this way, when the user wakes up she can immediately unpause the television program and proceed to watch the remaining portion of the television program or go back to a prior portion that was missed as the user was starting to fall asleep. Alternatively, the user can enter the DVR menu and select to play the remaining portion of the program from among the titles recorded in the DVR. In a similar manner, if the user is watching a movie on DVD or Blu-ray, the DVD or Blu-ray player can immediately cause the DVD or Blu-ray to stop upon being notified by the wireless headset 24 that the user has fallen asleep. Those of skill in the art will recognize that many other actions can be taken by the television receiver or other media devices for the user's convenience upon being notified that the user has fallen asleep.

The sensor 28 can also cause the transceiver 26 of the wireless headset 24 to turn back on when the user wakes up. For example, if the sensor 28 has caused the wireless transceiver 26 to turn off because the sensor 28 has detected that the user has fallen asleep, the sensor 28 can still be in a functioning state and continue to monitor the physical state of the user. If the physical state of the user indicates that the user has woken up, the sensor 28 can cause the transceiver 26 to turn back on and to continue to receive the audio portion of the media program. The wireless headset 24 can also transmit signals to the television receiver 22 or other media devices indicating that the user has woken up. The television receiver 22 or other media devices that have entered a low power mode and/or paused or recorded a media program can immediately resume playing the media program upon notification that the user has woken up. Alternatively, the television receiver 22 or other media device can notify the user that the media program was paused or recorded upon detecting that the user fell asleep. The television receiver 22 or other media device can prompt the user for input regarding whether the user would like to immediately begin playing the paused or recorded program.

In one embodiment, the television receiver 22 includes a sensor 29 that can monitor a physical state of the user. The sensor 29 of the television receiver 22 detects that the user has fallen asleep, the television receiver 22 can transmit a signal via transceiver 27 to the wireless headset 24 indicating that the user has fallen asleep. In response to receiving the signal from the television receiver 22, the wireless headset 24 can enter a low power mode by turning off the transceiver 26 or by shutting down altogether.

In one embodiment, the sensor 29 of the television receiver 22 includes a camera that can monitor the eyes of the user. Sensor 29 can detect if the user's eyes are closed. If the sensor 29 detects that the user's eyes are closed for an extended period of time, then the television receiver 22 determines that the user is asleep. The television receiver 22 then transmits a signal to the wireless headset 24 causing the wireless headset 24 to enter a low power or shutdown mode as described previously. Further details regarding the features of a television receiver 22 or other media device that monitors a user's eyes can be found in U.S. patent application Ser. No. 13/910,804, hereby incorporated by reference in its entirety. Other systems, such as Xbox One and Kinect that are known in the art can also be used.

The television receiver 22 can also monitor and dynamically learn the user's habits/routines and use that information to determine when to automatically power down the wireless headset 24. For example, the television receiver 22 detects that the user commonly watches the evening news and then turns off the television receiver 22 and the wireless headset 24 after the news has ended. On a particular day, the television receiver 22 may detect that the user has not powered down the television receiver 22 and the wireless headset 24 after the conclusion of the evening news. The television receiver can assume that the user might have fallen asleep and that this is the reason for the break from the user's normal routine. The television receiver 22 outputs a prompt on a display indicating that the system 20 will be powered down unless the user provides feedback such as an audible statement command detected by the headset 24 or the television receiver 22, a button press on the wireless headset 24 or on a remote control, etc. If the user does not respond then the wireless headset 24 and the television receiver 22 are powered down.

While many of the features of the system 20 have been described in relation to a television receiver 22 and the wireless headset 24, principles of the present disclosure extend to 3-D glasses or other types of headwear or devices that can be worn by a user in conjunction with viewing media programs. Thus, the 3-D glasses can include the sensor 28 that detects whether the user has fallen asleep and can cause the 3-D glasses to enter into a low power state. Likewise, the television receiver 22 or other media device can transmit a signal to the 3-D glasses causing the 3-D glasses to enter a low power or shutdown state at the end of a selected media program, at a selected time, or upon detecting that the user has fallen asleep.

While a wireless headset 24 has been shown to include a single transceiver 26, those of skill in the art will understand that the wireless headset 24 can include multiple wireless receivers and transmitters. Upon detecting that a user is asleep, the wireless headset 24 may shutdown one or more of the wireless receivers and transmitters while leaving other wireless receivers and transmitters still functioning. For example, in one embodiment the transceiver 26 includes a Bluetooth transceiver that receives the audio portion of the media program. The Bluetooth transceiver can be shutdown when the user falls asleep while other transceivers may still be active. Many configurations of the transceiver 26 are apparent in light of the present disclosure. All such configurations fall within the scope of the present disclosure.

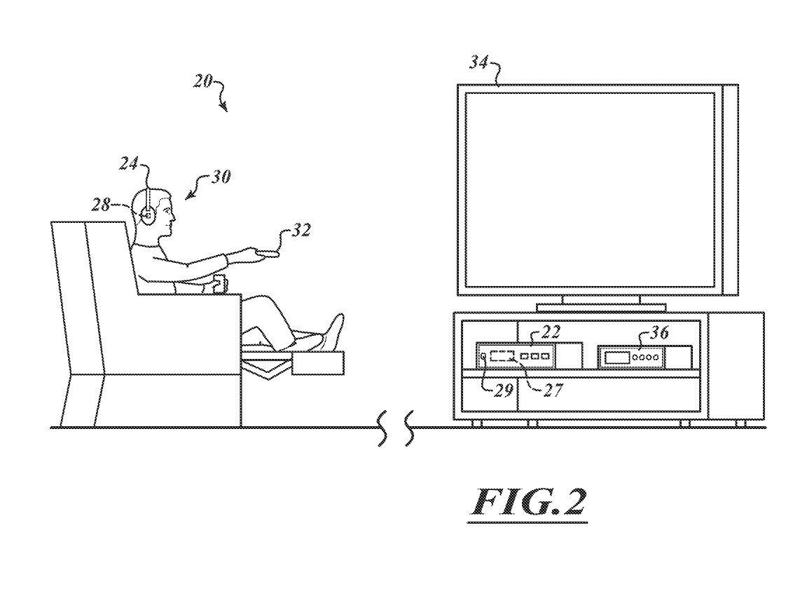

FIG. 2 is an illustration of a residential setting including a media presentation system 20 according to one embodiment. The media presentation system 20 includes a television receiver 22, the wireless headset 24 worn by a user 30, a remote control 32 held by the user 30, a television 34 coupled to the television receiver 22, and an electronic media device 36 coupled to the television receiver 22 and the television 34. The wireless headset 24 includes a transceiver 26 and a sensor 28. The television receiver 22 includes a transceiver 27 and a sensor 29.

In one embodiment, the television receiver 22 receives media content from a satellite television service provider, cable television provider, the Internet, terrestrial broadcast signals, etc. The television receiver 22 displays media programs on the television 34. The user 30 can operate a remote control 32 to control the television receiver 22. The user 30 can select media programs to be displayed on a television 34 by the television receiver 22. The audio portion of the media programs are transmitted from the transceiver 27 to the wireless headset 24. The user 30 hears the audio portion of the media program via the headphones of the wireless headset 24.

By using the remote control 32, the user 30 can access menu screens of the television receiver 22. In the menu screens, the user can select a particular media program after which the television receiver 22 should transmit a command to the wireless headset 24 to enter a low power mode or to shut down altogether. For example, the user may wish to watch Sports Center at 10 PM on ESPN. Prior to or during viewing of Sports Center, the user can access the programming guide and can select Sports Center as a final media program to be viewed that night. In this way the user can tell the television receiver 22 to transmit the signal to the wireless headset 24 causing the wireless headset to enter the low power or shutdown mode at the conclusion of the program. In another example, at the end of Sports Center, the television receiver 22 can cease transmitting the audio portion to the wireless headset 24. The wireless headset 24 can preserve power by not actively receiving the audio portion of the broadcast.

Alternatively, from the menu screens of the television receiver 22, the user can select a particular time at which to transmit the signal to the wireless headset 24 causing the wireless headset to enter a reduced power mode or to shut down altogether.

In one example, the user can sit down to the various television programs on the television 34. The user expects to be done watching television by 1 AM. In particular, the user expects either to have fallen asleep while watching television or to have gone to bed by 1 AM. The user therefore accesses the menu screens of the television receiver 22 and designates 1 AM as a time after which the wireless headset should enter a low power mode and/or the audio portion of the media programs should no longer be transmitted to the wireless headset 24 from the television receiver 22. Therefore, at 1 AM the television receiver 22 transmits a signal to the wireless headset 24 causing wireless headset 24 to enter the low power or shutdown state. The television receiver 22 can also turn off or cease transmitting the audio portion of the media program to the wireless headset 24.

In one embodiment, the sensor 28 of the wireless headset 24 monitors a physical state of the user such as head motion, head orientation, pulse, breathing rate etc. to detect when the user has fallen asleep. If the sensor 28 detects that the user 30 has fallen asleep, then the sensor 28 can cause the wireless headset 24 to enter a low power mode by shutting down the transceiver 26 or a particular portion of the transceiver 26. The sensor 28 can also cause the entire wireless headset 24 to shut down.

In one embodiment, the television receiver 22 includes a sensor 29, to monitor a physical state of the user 30 such as whether the user's eyes are open. If the sensor 29 detects that the user has fallen asleep, then the television receiver 22 can transmit a signal to the wireless headset 24 causing the wireless headset 24 to enter a low power or shutdown mode.

The media device 36 can be a game console, a DVD player, stereo system or other electronic media device that plays media programs that include an audio portion. The media device 36 transmits the audio portion of the media program to the wireless headset 24. The television receiver 22 can be configured to cause the media device 36 to shut down at a particular time or after a particular program has selected by the user 30. The television receiver 22 can also cause the media device 36 to stop transmitting an audio portion of the media program to the wireless headset 24 at the particular time or after the particular media program has ended. Alternatively, the media device 36 can include functionality allowing the user to select a particular time to cease transmission of the audio portion to the wireless headset 24 or to send a signal to the wireless headset 24 causing the wireless headset 24 to enter the low power or shutdown mode as described previously. Those of skill in the art will recognize that many configurations of the electronic device 36 and television receiver 22 are possible in light of the present disclosure. All such other configurations of the electronic device 36 and television receiver 22 fall within the scope of the present disclosure.

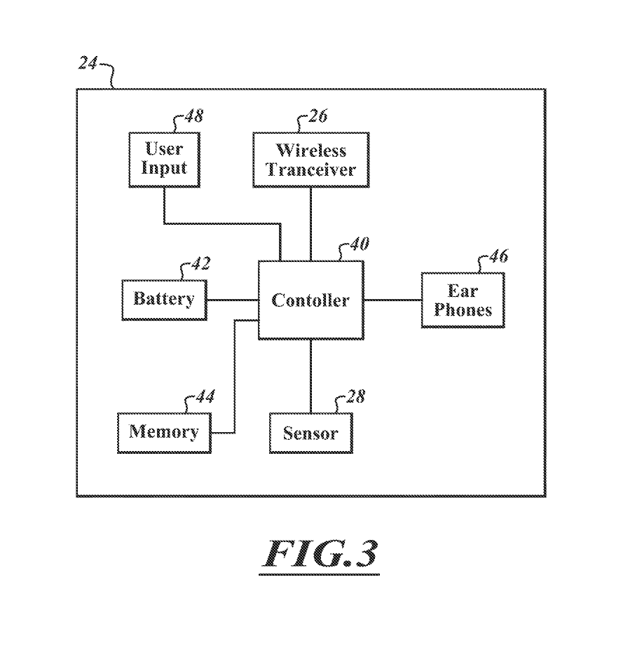

FIG. 3 is a block diagram of a wireless headset 24 according to one embodiment. The wireless headset 24 includes a controller 40. The controller 40 is coupled to a battery 42. The controller 40 is further coupled to a memory 44, earphones 46, user input keys 48, wireless transceiver 26, and the sensor 28.

The memory 44 can include one or more of an EEPROM, ROM, SRAM, DRAM, flash RAM, or other types of memory devices. The controller 40 executes instructions stored in the memory 44 to perform the functions of the wireless headset 24.

The wireless transceiver 26 includes one or more wireless transmitters and receivers by which the wireless headset 24 communicates with other devices. The controller 40 controls the wireless transceiver 26. The wireless transceiver 26 receives the audio portion of the media program from a television receiver 22 or other media device 36 as described previously. In one embodiment, the wireless transceiver 26 includes IR and RF transmitters and receivers including a Bluetooth transceiver that receives the audio portion of the media program from the television receiver 22 or other media device 36. The wireless transceiver 26 can also transmit signals to the television receiver 22 and other electronic media devices 36 indicating that the user 30 has fallen asleep. In this way the wireless transceiver 26 can cause the television receiver 22 or other electronic media devices 36 to pause or record the media program, to enter a low power mode, etc., as described previously.

The earphones 46 include speakers that output the audio portion of the media program as an audible sound to the user 30. In particular, the earphones 46 fit on or inside the ears of the user 30 and output sound to the user 30 received via the wireless transceiver 26.

The user input keys 48 are the inputs by which a user 30 can control the wireless headset 24. User input keys 48 can include on, off, and standby keys, volume control keys, wireless transceiver control keys or any other keys suitable for allowing the user 30 to interact with and control the wireless headset 24.

The user inputs 48 can also be on the remote control for the television receiver 22. The remote control can send signals to the television receiver which will store the program for the headset 24 and then output signals to control it.

The sensor 28 monitors the physical state of the user. The sensor 28 can detect whether the user 30 has fallen asleep based on the physical state monitored by the sensor 28. The sensor 28 can include one or more accelerometers, gyroscopes, microphones, pulse rate monitors, breathing monitors, cameras, or any other suitable device for detecting whether the user 30 has fallen asleep. The controller 40 controls the sensor 28 and receives signals from the sensor 28 indicating the physical state of the user 30. In one embodiment, the controller 40 detects whether or not the user has fallen asleep based on comparing the signals received from the sensor 28 to data stored in the memory 44. If the controller 40 determines that the user has fallen asleep, the controller 40 can cause the wireless transceiver 26 to output a signal to the television receiver 22, the television 34, or any other electronic media devices 36. The controller 40 can shut down the wireless transceiver 26 or a portion of the wireless transceiver 26 based on instructions stored in the memory 44. The controller 40 can also cause the entire wireless headset 24 to shut down. In this way, the sensor 28 and the controller 40 can preserve the life of the battery 42 by shutting down one or more portions of the wireless headset 24 when the sensor 28 indicates that the user 30 has fallen asleep. The controller 40 can also cause the wireless transceiver 26 or other components of the wireless headset 24 to wake up and resume full functionality when the sensor 28 indicates that the user has woken up.

Those of skill in the art will understand that the wireless headset 24 can include many more or fewer components than those disclosed in the block diagram of FIG. 3 depending on the particular specification and design of the wireless headset 24 in accordance with principles of the present disclosure. All other configurations of the wireless headset 24 fall within the scope of the present disclosure.

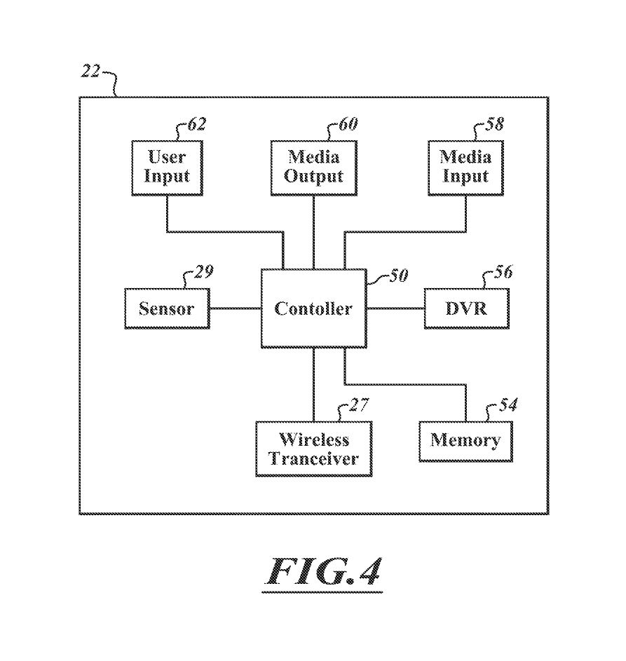

FIG. 4 is a block diagram of a television receiver 22 according to one embodiment. The television receiver 22 includes a controller 50 coupled to a media input 58. Controller 50 is also coupled to a media output 60, user input 62, sensor 29, a wireless transceiver 27, a memory 54, and a DVR 56.

The media input 58 receives media program data or signals from a satellite television provider, cable television provider, terrestrial broadcast signals, other electronic media devices coupled to the television receiver 22, or any other suitable source of media programs. The media input 58 is controlled by the controller 50.

The media output 60 outputs media programs to a display 34 or other electronic media devices coupled to the television receiver 22 either by a wired connection or a wireless connection. For example, when the television receiver 22 receives a media program from a content provider via the media input 58, the controller 50 processes the input media program and outputs the video portion of the media program to the display 34 via the media output 60.

The digital video recorder (DVR 56) records media programs selected by the user and stores them in memory. In one embodiment, when the television receiver 22 receives a signal from the wireless headset 24 indicating that the user has fallen asleep, the controller 50 causes the DVR 56 to record the remaining portion of the media program currently being viewed.

The memory 54 stores data and software instructions for execution by the controller 50. In particular, the controller 50 controls the various components of the television receiver 22 in accordance with instructions stored in the memory 54 and input received from the user 30.

The wireless transceiver 27 includes one or more wireless receivers and transmitters. The wireless transceiver 27 can include one or more infrared receivers and transmitters, one or more RF receivers and transmitters, a Bluetooth transceiver, etc. In one embodiment, the wireless transceiver 27 transmits to the headset 24 a signal causing the wireless headset 24 to enter a low power or shutdown mode as described previously. The wireless transceiver 27 can also transmit signals to the television 34 or the other electronic media devices 36 causing them to enter a low power or shutdown mode as described previously. The wireless transceiver 27 also receives signals from the remote control 32 by which the user controls the television receiver 22.

The user input 62 can include one or more keys, buttons or other input controls on the face of the television receiver 22. The user input 62 can include keys for allowing the user 30 to manually turn off the television receiver 22, to change the channel of the television receiver 22, or to perform other common input commands for controlling a television receiver 22.

The sensor 29 monitors a physical state of the user 30 while the user is wearing the wireless headset 24. As described previously, if the sensor 29 detects that the user 30 has fallen asleep while viewing a media program the television receiver 22 outputs a signal to the wireless headset 24 causing the wireless headset 24 to enter a low power or shutdown mode. In one embodiment, the sensor 29 includes one or more cameras that track the movements of the user's eyes or head to determine if the user is asleep. The cameras can also detect if the user's eyes are opened and closed. The television receiver 22 can determine if the user is asleep based on the sensor 29 as described previously.

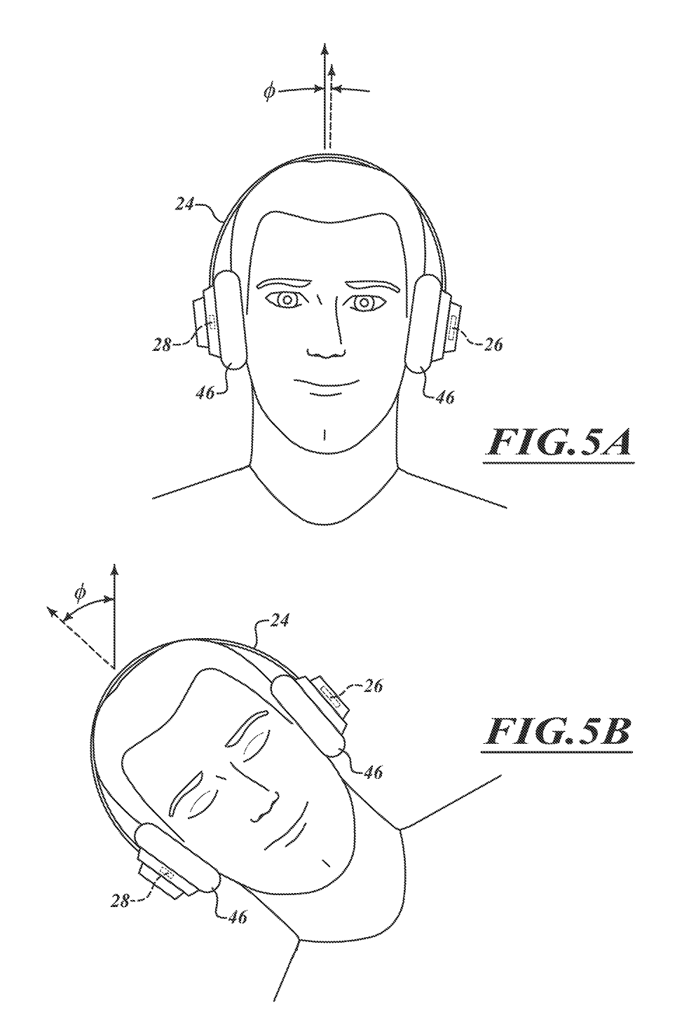

FIG. 5A is an illustration of the user 30 wearing a wireless headset 24 while viewing a media program. The wireless headset 24 receives the audio portion of the program as described previously. The audio portion of the program is provided to the user 30 via the headphones 46 of the television receiver 24. The wireless headset 24 includes a transceiver 26 by which the wireless headset 24 receives the audio portion of the media program. The wireless headset 24 further includes sensor 28 which detects the movements and orientation of the users head.

In one embodiment, the sensor 28 includes one or more accelerometers and/or gyroscopes that detect the orientation of the users head. In FIG. 5A the user's head is oriented at a small angle theta with respect to vertical. Sensor 28 monitors the angle the users head with respect to vertical. While the users head is upright and oriented at a small angle theta with respect to vertical, the sensor 28 detects that the user is awake.

In FIG. 5B, the user has fallen asleep while watching the media program. Wirelessly, the user's position has shifted such that the users head now makes a much larger angle theta with respect to vertical. In one embodiment, if the sensor 28 of the wireless headset 24 detects that the user's head is oriented with an angle theta that is larger than a threshold angle for a period of time exceeding a threshold time, the sensor 28 determines that the user has fallen asleep. In one example, the threshold angle is 30° with respect to vertical and the threshold time is five minutes. Other suitable values for the threshold angle and threshold time can be chosen as will be recognized by those of skill in the art in light of the present disclosure. In determining whether the user has fallen asleep, the sensor 28 can take into account whether the user's head is leaning back, to the side, etc.

In one embodiment, the sensor 28 monitors the movements of the users head. While a user is awake, the user's head will typically make small movements from time to time such as briefly looking away from the television 34, nodding, jostling due to laughter, etc. When the sensor 28 detects such characteristics head movements, the sensor 28 determines that the user is still awake. However, when the user has fallen asleep, the users head will typically not move at all for relatively long periods of time. If the sensor 28 determines that the users head has not move significantly for a duration of time greater than a threshold period of time, the sensor 28 determines that the user has fallen asleep. Sensor 28 causes the transceiver 26 to power down as described previously.

The sensor 28 can be utilized in many ways to determine if the user has fallen asleep. The sensor 28 can determine whether the user has fallen asleep based on a combination of head orientation and head movements or other factors as will be apparent to those of skill in the art in light of the present disclosure. All such ways of determining whether the user has fallen asleep fall within the scope of the present disclosure.

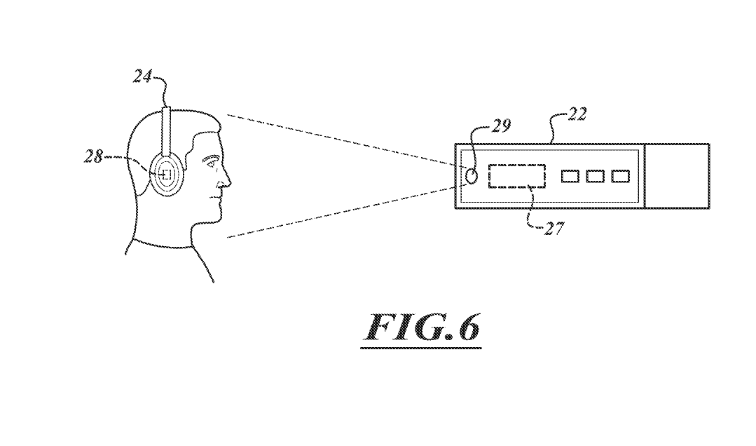

FIG. 6 is an illustration of a user 30 viewing a media program while wearing a wireless headset 24. The television receiver 22 is monitoring the user via a sensor 29 to detect if the user has fallen asleep. In the illustration of FIG. 6 the television receiver is shown as being directly in front of the user and at a level with the users head. In practice, the television receiver 22 may not be directly in front of the user but will be above, below, or to the side of a television 34 on which the user is viewing the media program.

In one embodiment the sensor 29 includes one or more cameras that monitor the user's eyes. The camera can monitor the user's eyes to determine if the user is awake or asleep. If the sensor 29 detects that the user's eyes are closed for a period of time longer than a threshold period of time, the sensor 29 determines that the user has fallen asleep and transmits the power down command to the wireless headset 24 as described previously.

Alternatively, the sensor 29 can monitor the orientation and/or movements of the users head. As described previously, the orientation and movements of the users head provide an indication of whether the user is awake or sleep. If the sensor 29 determines that the user has fallen asleep based on the movements and/or orientation of the users head, the television receiver 22 transmits the power down command to the wireless headset 24 as described previously.

In one embodiment, the sensor 29 is a video camera that detects when the user is wearing the wireless headset 24. If the video camera 29 indicates that the user is not wearing the wireless headset 24, then the television receiver 22 can transmit a command to power down the wireless headset 24. In a similar manner, if the video camera indicates that the user has put on the wireless headset 24, then the television receiver 22 can transmit a command to turn on the wireless headset 24. Alternatively, the sensor 29 can be a camera that periodically takes a picture. The television receiver 22 then analyzes the picture to determine whether or not the wireless headset is being worn by the user and powers down or powers on the wireless headset 24 accordingly.

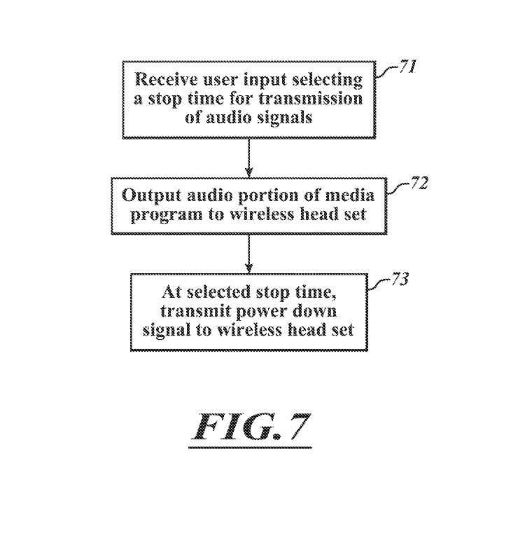

FIG. 7 is a flowchart of a process for preserving batteries in a wireless headset 24 worn by a user while viewing a media program as described previously. At 71 the user inputs via a remote control 32 commands to a television receiver 22 indicating that at the end of a particular program or at a particular time, the television receiver 22 should send a power down signal to the wireless headset 24 in order to preserve the battery life of the wireless headset 24 in case the user falls asleep while wearing the wireless headset 24 or forgets to turn off the wireless headset 24.

At 72, the television receiver 22 outputs to the wireless headset 24 the audio portion of a media program that the user is viewing on the display coupled to the television receiver 22. At 73, the selected program ends or the selected stop time arrives and the television receiver 22 transmits a power down signal to the wireless headset 24. When the wireless headset 24 receives the power down signal, the wireless headset 24 turns off wireless transceiver 26 or shuts down altogether.

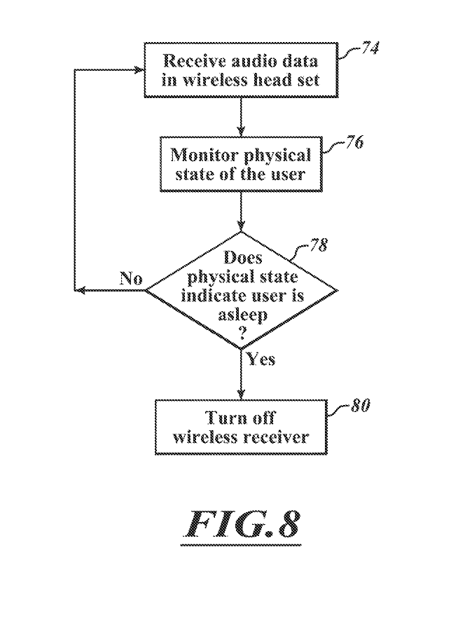

FIG. 8 is a flowchart of a process for preserving batteries in a wireless headset 24 according to an alternative embodiment. At 74, the wireless headset receives the audio portion of a media program from a television receiver 22. At 76, sensor 28 and/or 29 monitors a physical state of the user. The sensor 28 and/or 29 can be housed in the television receiver 22 or in the wireless headset 24 as described previously. At 78, if the sensor 28 and/or 29 detects that the user has not fallen asleep, the wireless headset 24 continues to receive the audio portion of the media program. If the sensor 28 and/or 29 detects that the user has fallen asleep then at 80 the transceiver 26 of the wireless headset 24 is powered down.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, in a wireless headset worn by a user, an audio portion of a media program;
monitoring, in a sensor, a physical state of the user;
detecting, in the sensor, that the user has fallen asleep based on the physical state; and
turning off a wireless receiver of the headset in response to detecting that the user has fallen asleep

2. The method of claim 1 wherein the sensor is an inertial sensor coupled to the wireless headset.

3. The method of claim 2, comprising determining that the user has fallen asleep based on movements of the user's head detected by the inertial sensor.

4. The method of claim 2 wherein monitoring the physical state of the user comprises detecting, based on the output of the inertial sensor, an orientation of the headset.

5. The method of claim 3, comprising detecting that the user has fallen asleep if the headset has a particular orientation for a period of time longer than a threshold time.

6. The method of claim 4 wherein the orientation indicates that the user's head is no longer upright.

7. The method of claim 1 wherein monitoring the physical state comprises monitoring the user's breathing.

8. The method of claim 1 wherein monitoring the physical state comprises monitoring whether eyes of the user are shut.

9. The method of claim 1 wherein monitoring the physical state comprises monitoring a heart rate of the user.

10. The method of claim 1, comprising transmitting a signal from the wireless headset to a television receiver upon detecting that the user has fallen asleep.

11. The method of claim 10, comprising turning off the television receiver in response to receiving the signal in the television receiver.

12. The method of claim 10, comprising turning off a television coupled to the television receiver in response to receiving the signal in the television receiver.

13. The method of claim 1, comprising turning the wireless receiver back on in response to detecting that the user has woken up.

14. The method of claim 1, comprising:
transmitting the audio portion of the media program from a television receiver to the wireless headset; and
transmitting a power-down signal from the television receiver to the wireless headset in response to detecting that the user has fallen asleep.

15. A method, comprising:
transmitting audio data from a television receiver to a wireless headset;
receiving, in a television receiver, a user input selecting a condition for transmitting a power-down signal to the wireless headset; and
transmitting the power-down signal to the wireless headset upon fulfillment of the condition.

16. The method of claim 15 wherein the condition is an end of a selected media program.

17. The method of claim 15 wherein the condition is a particular time of day.

18. A wireless headset, comprising:
a wireless receiver configured to receive an audio portion of a media program;
a speaker configured output the audio portion to a user of the wireless headset;
a sensor configured to monitor a physical state of the user and to output a sensor signal indicative of the physical state; and
a controller coupled to the wireless receiver, the speaker, and the sensor and configured to receive the sensor signal and to turn off the wireless receiver when the sensor signal indicates that the user has fallen asleep.

19. The wireless headset of claim 18 wherein the sensor is an inertial sensor configured to monitor an orientation of the headset.

20. The wireless headset of claim 19 wherein the controller is configured to turn off the wireless receiver when the sensor signal indicates that the user's head has not been upright for a period of time longer than a threshold time.
